(19) United States
(12) Patent Application Publication
(10) Pub. No.: US 2007/0067445 A1
(43) Pub. Date: Mar. 22, 2007

(54) Remote computer wake-up for network applications

(75) Inventors: Yan Vugenfirer, Netanya (IL); Ronen Bartal, Emek Hefer (IL); Gil Koifman, Netanya (IL)

Correspondence Address: LADAS & PARRY, 26 WEST 61ST STREET, NEW YORK, NY, 10023, US

(73) Assignee: SMART LINK LTD.

(21) Appl. No.: 11/439,887

(22) Filed: May 24, 2006

Related U.S. Application Data
(60) Provisional application No. 60/717,257, filed on Sep. 16, 2005.

(51) Int. Cl. G06F 15/173

(52) U.S. Cl. 709/224

(57) ABSTRACT

A method for computer-based communication includes storing at a first computer records of correspondence between application-specific identifiers used in a network application and network addresses of computers on a network that are respectively associated with the application-specific identifiers. A second computer is powered down after storing at the first computer a record of the correspondence between an application-specific identifier and a network address associated with the second computer. If it is determined, while the second computer is powered down, that a message is to be directed by the network application to the application-specific identifier associated with the second computer, a wake-up packet is sent over the network to the network address specified by the record, so as to cause the second computer to power up and respond to the message.

### CROSS-REFERENCE TO RELATED APPLICATION

This application claims the benefit of U.S. Provisional patent application 60/717,257, filed Sep. 16, 2005, which is incorporated herein by reference.

### FIELD OF THE INVENTION

The present invention relates generally to computer systems, and specifically to remote control via network of computer power state.

### BACKGROUND OF THE INVENTION

Many computer users power down their computers when not in use. Some users may turn off their computers entirely, but frequently the computer is powered down by placing the computer in “standby” or “hibernate” mode. In these power-down modes, the computer's power consumption is drastically reduced, but the computer can be powered up and resume normal operation on command quickly. In the context of the present patent application and in the claims, a “power-down mode” refers to any state of the computer in which at least some of the functions and/or components of the computer are deactivated in order to reduce power consumption; and to “power down” the computer means to place the computer into a power-down mode of this sort.

A number of solutions have been developed to enable computers to be powered up remotely, without requiring that the user be present at the keyboard. For example, U.S. Pat. No. 5,938,771, whose disclosure is incorporated herein by reference, describes a network interface that enables power up of a host computer using a “Magic Packet” scheme. According to this scheme, the network interface scans incoming Ethernet data frames for one of two MAC (medium access control) addresses repeated sixteen times within the information field of the frames. When the network interface detects one of these frames, it generates a power management wake-up signal to initiate a wake-up routine of the host computer. Thus, the network interface can be automatically configured for power management operation by detecting wake-up requests in data packets received from a network, regardless of the state of the host computer.

01 Communique Inc. (Toronto, Ontario) offers remote wake-up technology, which allows a remote employee, using a Web browser, to power up a computer that was previously shut down. The technology uses a wake-up server housed on the customer business premises and at least one PC on the LAN that is designated as the “wake-up proxy” and is always on. The wake-up server stores the computer name, MAC address, and wake-up password for the target PC of the remote employee. Once the employee has been authenticated by the wake-up server, the server finds the designated wake-up proxy and passes along the MAC address of the target PC. The wake-up proxy sends a wake signal to the target PC, causing the PC to power on. The employee completes authentication and can then use the PC. 01 Communique announced the availability of this remote wake-up technology after the filing date of the above-mentioned provisional patent application.

### SUMMARY OF THE INVENTION

The “Magic Packet” scheme described above requires that the computer transmitting the wake-up frame know the MAC address of the network interface of the computer that is to be powered up. This sort of scheme may therefore be effective in an enterprise local area network (LAN), in which a system administrator can ensure that lists of MAC addresses are maintained and updated, but it is less effective in wide area network (WAN) applications. For example, when an Internet telephony user wishes to place a voice over Internet Protocol (VoIP) call to a remote user of a target computer that has been placed in standby mode, the VoIP application will typically identify the remote user as unavailable. In systems known in the art, the user placing the call generally does not have access to the MAC address of the target computer and is therefore unable to wake up the destination computer in order to receive the call.

One aspect of the present invention addresses this difficulty by providing methods and systems that enable remote wake-up of a target computer in response to an application message sent from a remote computer, which does not necessarily have a record of the actual physical address (such as the MAC address) of the target computer. In some embodiments, an intermediary computer registers the correspondence between application-specific identifiers of computer users and the physical addresses of the their computers, and may also record the respective power states of the computers. The intermediary computer in this context may be a dedicated server, or it may alternatively be a peer computer running appropriate software. Multiple peers may thus act as wake-up intermediaries for one another.

In some embodiments, a wake-up server intercepts application messages that are directed to registered users, who are identified by their application-specific identifiers. When the wake-up server determines that the user's computer is powered down, its sends a wake-up packet to the computer. Appropriate wake-up hardware and software on the computer recognize the wake-up packet, and in response to the packet power-up the computer, so that the application software can receive and respond to the message. In this manner, for example, the computer can receive and notify the user of an incoming VoIP call even when the computer is powered down. Similar techniques may be used to respond to messages from other applications, such as e-mail, news and instant messaging, as well as remote control for user access and management applications.

There is therefore provided, in accordance with an embodiment of the present invention, a method for computer-based communication, including:

storing at a first computer records of correspondence between application-specific identifiers used in a network application and network addresses of computers on a network that are respectively associated with the application-specific identifiers;

powering down a second computer after storing at the first computer a record of the correspondence between an application-specific identifier and a network address associated with the second computer;

determining, while the second computer is powered down, that a message is to be directed by the network application to the application-specific identifier associated with the second computer; and

sending a wake-up packet over the network to the network address specified by the record, so as to cause the second computer to power up and respond to the message.

In exemplary embodiments, the network application includes at least one of an Internet telephony application, an instant messaging application, an e-mail application, a news application, and a video delivery application. Typically, the network includes the Internet. The first and second computers need not be located on a common local area network (LAN).

In some embodiments, sending the wake-up packet includes inserting in the wake-up packet a specific data pattern to which the second computer is configured to respond, and storing the record includes storing an indication of the specific data pattern. Optionally, the specific data pattern includes a physical address of the second computer. The specific data pattern may be contained in the message to be directed by the network application.

In some embodiments, storing the records includes recording respective power states of the computers, and sending the wake-up packet includes determining that the wake-up packet should be sent responsively to an indication in the record that the second computer is powered down. In one embodiment, determining that the message is to be directed includes intercepting at an intermediary computer messages directed by the network to the application-specific identifier. Typically, intercepting the messages includes sending packets from the intermediary computer to a server associated with the network application so as to cause the server to send the messages to the intermediary computer while the second computer is powered down. The intermediary computer may be configured to serve as a proxy for the second computer. Additionally or alternatively, the intermediary computer may include a wake-up server, which stores the records and sends the wake-up packet.

In another embodiment, the second computer is connected to the network via a local area network (LAN) together with a third computer, and the third computer is configured to receive packets directed to the network address indicated by the record, and sending the wake-up packet includes prompting the third computer to send the wake-up packet to the second computer.

In a disclosed embodiment, at least one of the records associates multiple network addresses with one of the application-specific identifiers. Additionally or alternatively, at least two of the records associate different, respective application-specific identifiers with a single, common network address.

Further additionally or alternatively, storing the records may include storing an access control list identifying sources of the message that are permitted to cause the second computer to power up.

There is also provided, in accordance with an embodiment of the present invention, a method for computer-based communication, including:

storing at a first computer records of correspondence between network addresses of computers on a network and power states of the computers;

powering down a second computer while storing at the first computer a record indicating that the second computer has powered down;

determining, while the second computer is powered down, that a message is to be directed by a network application to the second computer; and

responsively to the record, sending a wake-up packet to the second computer, so as to cause the second computer to power up and respond to the message.

There is additionally provided, in accordance with an embodiment of the present invention, apparatus for computer-based communication, including:

a memory, which is configured to store records of correspondence between application-specific identifiers used in a network application and network addresses of computers on a network that are respectively associated with the application-specific identifiers; and

a wake-up processor, which is arranged to receive, via the network, and to store in the memory a record of the correspondence between an application-specific identifier and a network address associated with a given computer, and to determine, while the given computer is powered down, that a message is to be directed by the network application to the application-specific identifier associated with the given computer, and to send a wake-up packet over the network to the network address specified by the record, so as to cause the given computer to power up and respond to the message.

There is further provided, in accordance with an embodiment of the present invention, apparatus for computer-based communication, including:

a memory, which is configured to store records of correspondence between network addresses of computers on a network and power states of the computers; and

a wake-up processor, which is arranged to receive, via the network, and to store in the memory a record indicating that a given computer is powered down, and to determine, while the given computer is powered down, that a message is to be directed by a network application to the second computer, and responsively to the record, to send a wake-up packet to the given computer, so as to cause the given computer to power up and respond to the message.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a remote wake-up system, in accordance with an embodiment of the present invention;

FIG. 2 is a block diagram that schematically shows functional elements of a computer that is configured for remote wake-up, in accordance with an embodiment of the present invention;

FIG. 3 is a flow chart that schematically illustrates a process for remote wake-up of a computer in response to an application message, in accordance with an embodiment of the present invention; and

FIG. 4 is a block diagram that schematically illustrates a remote wake-up system, in accordance with another embodiment of the present invention.

### DETAILED DESCRIPTION OF EMBODIMENTS

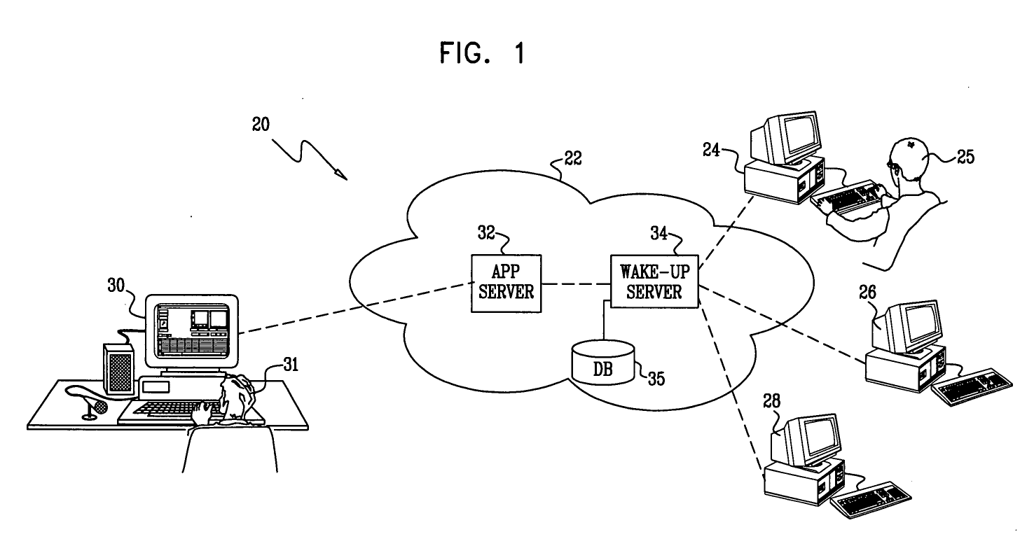

FIG. 1 is a block diagram that schematically illustrates a remote wake-up system 20, in accordance with an embodiment of the present invention. In this exemplary embodiment, users of computers 24, 26, 28, 30 communicate via a network 22. As an aid to understanding this embodiment, it will be assumed that network 22 comprises the Internet, and that the users exchange messages in the context of a VoIP application. The principles of the present invention, however, are applicable to a wide range of different message-based network applications, and may be implemented not only over the Internet, but on other types of WANs and LANs, as well. Some of these alternative applications are described further hereinbelow.

In the scenario shown in FIG. 1, a user 31 of computer 30 attempts to place a VoIP call to a user 25 of computer 24, for example. In response to the user input, the VoIP application running on computer 30 sends a call initiation message to a VoIP application server 32, which is typically operated by a VoIP service provider. The message identifies user 25 by means of an application-specific identifier (ID), such as a user name or telephone number. In typical VoIP applications, when computer 24 is powered up, the VoIP software on computer 24 automatically registers its IP address with server 32, so that the server is able to associate the application-specific ID of the user with the IP address. Thus, server 32 passes an appropriate call initiation message on to computer 24, and a call is thus set up between computers 24 and 30.

In the present example, however, it is assumed that computer 24 has been powered down, and is therefore in standby or in hibernation mode at the time the call initiated by computer 30. Typically, user 25 powers down the computer in order to save energy and/or money, or the computer may automatically power down during a period of inactivity. Computer 24 is therefore unable to receive the call itself.

In order to enable computers 24, 26 and 28 to receive calls even when powered down, the computers are configured to sense and respond to special wake-up packets, as described hereinbelow. These wake-up packets may comprise “Magic Packets,” as described above, containing the MAC address of the target computer that is to be woken up. Additionally or alternatively, the wake-up packets may contain some other predefined data pattern and/or application-specific or protocol-specific data.

A wake-up server 34 stores the application-specific ID that is associated with each of computers 24, 26 and 28 in a memory 35, together with the respective network address and wake-up data to which the computer is expected to respond. For example, in the case of the VoIP application, server 34 may store the user ID (such as the telephone number or Skype™ name of the computer user) together with the IP and MAC addresses of computer 24. Additionally or alternatively, server 34 stores the power state of computer 24 and thus is informed when the computer is powered down. Using this information, wake-up server 34 informs application server 32 that VoIP call setup messages directed to the user ID of user 25 are to be handled by server 34. The wake-up server need not be located on the same LAN or subnet as the client computers that it serves, but rather may communicate with the clients via the Internet or other WAN.

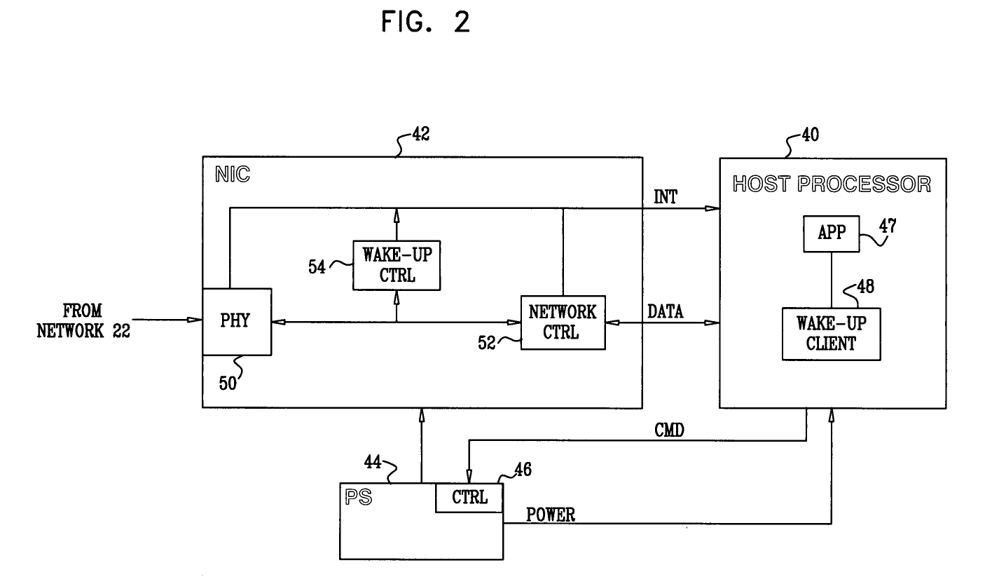

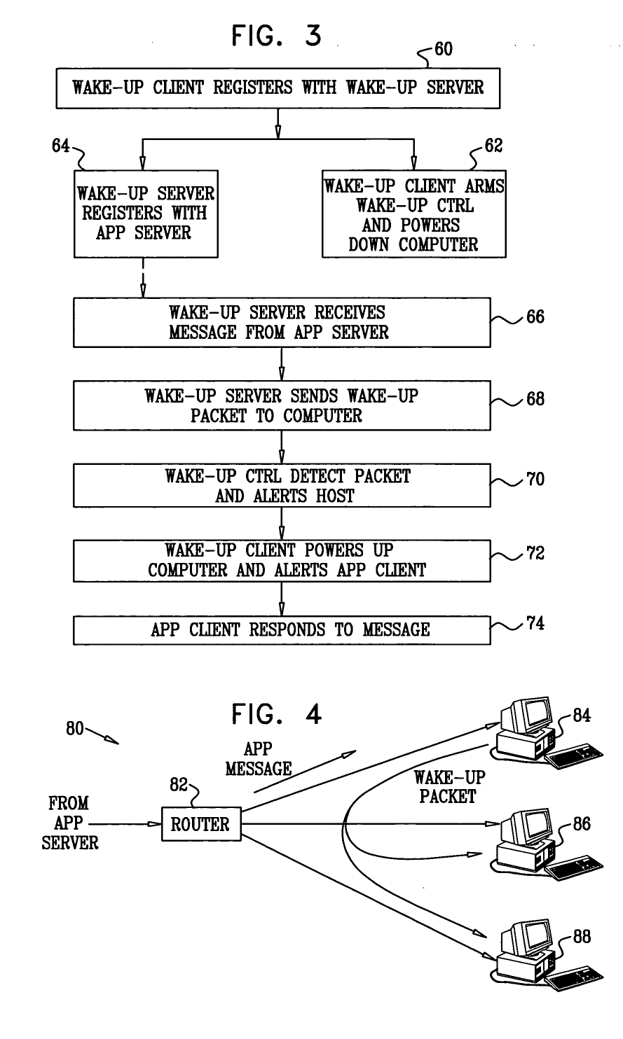

Thus, upon receiving the call initiation message from computer 30 while computer 24 is powered down, application server 32 notifies wake-up server 34, which in turn sends an appropriate wake-up packet to computer 24. Upon receiving the wake-up packet, computer 24 automatically powers up and is then able to notify user 25 of the incoming call. Call setup between computers 30 and 24 is then completed, and the call proceeds in the normal manner. Details of the operation of wake-up server 34 and computer 24 in this process are described with reference to FIGS. 2 and 3 hereinbelow.

Many variations are possible on the simplified scheme described above. For example, although wake-up server 34 is shown and described hereinabove as a stand-alone entity, the functions of the wake-up server may alternatively be integrated with the application server on the same computer platform or cluster of computers. Alternatively or additionally, the functions of the wake-up server may be integrated with access multiplexing equipment or other servers deployed by an Internet service provider (ISP). Further alternatively or additionally, functions of the wake-up server may be carried out by peer computers on the same LAN as computer 24, as described hereinbelow with reference to FIG. 4, for example, or by peer computers at other locations on network 22. The term “wake-up server” as used in the present patent application should therefore be understood as referring to any and all computers that implement the remote wake-up functions that are defined herein, whether the functions are implemented on a dedicated computer platform or are integrated with other operations on a shared computer platform.

Regardless of the system configurations, wake-up server 34 typically comprises a general-purpose computer processor, and the functions of wake-up server are carried out by the processor under the control of appropriate software. This software may be downloaded to the appropriate computer in electronic form, over a network, for example. Alternatively, the software may be supplied on tangible media, such as optical, magnetic, or electronic memory media.

For Internet telephony applications, as noted above, server 34 typically maintains a database in memory 35 that is keyed to VoIP-specific IDs, such as telephone numbers or Skype names. Each record in the database holds the network address of the user's computer (such as the IP address assigned to the computer) and the wake-up data that may be used to awaken the computer (MAC address or other data pattern). A given user ID may be associated with multiple records, so that an incoming VoIP call will wake up two or more different computers on which the user wishes to receive calls. Conversely, multiple user IDs may be keyed to the same network address (with the same or different wake-up data), so that the computer at the address will be woken up by incoming calls to any of the user IDs. The records may also indicate the respective power states of the computers in question, so that the server can determine whether a wake-up packet must be sent to the computer when an application message is to be directed to the computer.

Server 34 may maintain and apply access control lists in order to limit the range of calling computers that will be able to wake up a given target computer. In other words, for example, the database record for a given VoIP user ID may include an approved list or range of user IDs or addresses to which the wake-up server is to respond or, alternatively, a blacklist IDs or addresses to which the wake-up server should not respond. Thus, user 25 may, for example, instruct server 34 to wake up computer 24 upon receiving a call from business associates or family members, while rejecting nuisance calls.

Wake-up server 34 may be used in conjunction with other applications, as well, in addition to or instead of Internet telephony. In these and other applications, the “target computer” may be not only a personal computer, but also a specialized computer-based data receiver (such as a digital video recorder in the video application mentioned below). Examples of such functions include:
Instant messaging—Wake-up server 34 stores users' messaging IDs, such as ICQ numbers, and sends a wake-up packet to the target computer upon receipt of an incoming message. These functions may also be performed by the messaging service provider.
E-mail—Wake-up server 34 stores users' e-mail addresses and sends a wake-up packet to the target computer upon receipt of incoming e-mail from certain senders (or from any sender). These functions may also be performed by the e-mail server.
News—Wake-up server 34 or a news server stores subscriber IDs and sends a wake-up packet to the target computer upon receipt of a news item of interest.
Video—Wake-up server 34 or a video broadcast provider stores subscriber IDs and sends a wake-up packet to the target computer when a broadcast program of interest to the subscriber is about to start.
User-controlled PC wake-up—Wake-up server 34 enables a remote user to wake up his or her home or office computer for purposes of accessing data or running applications.
Enterprise applications—When enterprise IT assets are deployed in different geographical locations, the wake-up server may be used to control backup servers and provide remote access to assets at different geographical locations.

FIG. 2 is a block diagram that schematically shows functional details of computer 24, in accordance with an embodiment of the present invention. This is a simplified drawing, showing only the hardware and software components of the computer that are necessary for an understanding of this embodiment. Integration of these components into a complete computer will be straightforward for those skilled into the art.

Computer 24 comprises a host processor 40 and a network interface card (NIC) 42, which are both powered by a power supply 44. In many computers, NIC 42 provides an Ethernet interface and is integrated in the form of a chip or chip set (rather than an actual card) on the motherboard of the host processor. For the sake of clarity, however, the host processor and NIC are shown here as separate entities. A power controller 46 determines how power is to be applied to the elements of computer 24, subject to commands from host processor 40. In normal operating mode, power supply 44 typically supplies full power to all elements of the computer. In sleep or hibernation mode, however, host processor 40 may be powered down, but the power supply continues to provide sufficient power to NIC 42 in order to enable the NIC to receive and recognize wake-up packets from server 34.

Host processor 40 runs a communication application 47 and a wake-up client 48. The wake-up client is a program that is responsible, inter alia, for informing server 34 of the application-specific ID used in application 47 and of the wake-up data to be inserted by server 34 in wake-up packets sent to computer 24. For example, client 48 may read the MAC address that is hard-programmed into NIC 42 and supply the address to server 34. The wake-up client is also responsible for informing server 34 when computer 24 powers down, so that the server can intercept and act upon application messages that are directed to computer 24 following power-down. Although application 47 and client 48 are shown, for the sake of clarity, as separate functional blocks in FIG. 2, the functions of the wake-up client may also be implemented as part of application 47.

NIC 42 comprises a physical layer interface (PHY) 50 and a network controller 52, as are known in the art. In normal operation, PHY 50 demodulates incoming data from network 22 and passes the data to network controller 52, which performs packet processing functions and passes the data packets to host processor 40. When computer 24 is powered down, a wake-up controller 54 screens incoming data from PHY 50 in order to detect occurrence of a wake-up packet. Upon detecting a wake-up packet, wake up-controller 54 signals an interrupt to host processor 40, thus invoking wake-up client 48. The wake-up client instructs power controller 46 to power up computer 24 and activates application 47.

Wake-up controller 54 may be configured to recognize and respond to substantially any suitable data pattern in the wake-up packet. For example, as noted above, the wake-up controller may filter the incoming data stream for occurrences of the MAC address of NIC 42, which may be repeated in the wake-up packet multiple times as described in the above-mentioned U.S. Pat. No. 5,938,771. Alternatively, other arbitrary data patterns may be used. Further alternatively or additionally, wake-up controller 54 may be programmed to recognize and respond to application-specific or protocol-specific data patterns, such as a pattern that occurs in VoIP call initiation messages in accordance with a given Internet telephony application or protocol. The wake-up controller may be hard-wired to recognize only a certain specific data pattern or patterns, or it may be programmable to recognize a range of different patterns. Typically, wake-up client 48 arms the wake-up controller before powering down the computer and, to the extent that the wake-up controller is programmable, indicates to the wake-up controller which pattern or patters to detect in the incoming data stream.

FIG. 3 is a flow chart that schematically illustrates a method for remote wake-up of computer 24, in accordance with an embodiment of the present invention. Wake-up client 48 registers computer 24 with wake-up server 34, at a client registration step 60. As noted earlier, upon registration, server 34 creates a record in memory 35 that is keyed to the application-specific user ID of user 25. The record typically lists the network address and wake-up pattern of computer 24, as well as the current power state of computer 24 and other pertinent data. Application 47 may also register with application server 32, so that the application server is aware that user 25 is on-line and will direct application messages to the network address of computer 24. Alternatively, wake-up server 34 may be configured to act as a proxy for computer 24, so that all messages between application server 32 and application 47 are conveyed through the wake-up server regardless of the power state of the computer.

When computer 24 is to be powered down (whether by user 25 or automatically), wake-up client 48 informs wake-up server 34 of the change in power state. The wake-up client arms wake-up controller 54 and then powers down computer 24, at a power-down step 62. Arming the wake-up controller causes it to begin scanning the incoming data stream from PHY 50 and to signal an interrupt when the appropriate wake-up pattern occurs in the data stream.

Wake-up server 34 registers with application server 32, at a server registration step 64. If the wake-up server is configured to serve as proxy for computer 24 at all times (regardless of the power state of computer 24), this step typically takes place immediately after step 60. Alternatively, as noted above, the server may permit computer 24 to communicate directly with application server 32 while computer 24 is powered up, and may then perform step 64 only when computer 24 powers down. In either case, wake-up server 34 typically registers with application server 32 using the application-specific ID of user 25, so that the application server will then direct messages for this ID to the network address of the wake-up server. The wake-up server may continue sending registration packets periodically to the application server in order to keep the registration alive while computer 24 is powered down. Alternatively, if the functions of wake-up server 34 are integrated with application server 32, as mentioned above, then step 64 may be replaced by suitable routines carried out internally within the application server.

While computer 24 remains powered down, wake-up server 34 may receive an application message from application server 32 that is directed to the application-specific ID of computer 24, at a message reception step 66. For example, the application server may send a call initiation message to the wake-up server in response to a request by user 31 to set up a call to user 25. Upon receiving this message, wake-up server 34 sends a wake-up packet over network 22 to computer 24, at a wake-up step 68. The wake-up packet is transmitted to the IP address of computer 24 and contains the MAC address of NIC 42 and/or other wake-up data, as noted above. If wake-up controller 54 is configured to detect the application-specific data pattern contained in call initiation messages, then the wake-up packet may be the actual call initiation packet. In this case, any incoming call will cause the computer to wake up.

NIC 42 receives and decodes the wake-up packet via PHY 50, whereupon wake-up controller 54 recognizes the MAC address or other wake-up data, at a packet detection step 70. The wake-up controller sends an interrupt signal in order to awaken host processor 40. The interrupt causes the host processor to invoke wake-up client 48, at a host invocation step 72. The wake-up client instructs power controller 46 to power-up computer 24 and alerts application 47 to the incoming message. Upon receipt of the call initiation packet, the application processes and responds to the message as required by the protocol in question, at a message response step 74.

FIG. 4 is a block diagram that schematically illustrates elements of a remote wake-up system 80, in accordance with an alternative embodiment of the present invention. In this embodiment, a router 82 connects multiple computers 84, 86, 88 on a LAN to a WAN on which application server 32 is located. At least one of the computers on the LAN—in this example computer 84—is powered up at substantially all times and serves as a wake-up relay for the other computers. In this case, wake-up server 34 need not store the IP addresses of all of the computers on the LAN. Rather, it is sufficient for the wake-up server to communicate with computer 84 when one of computers 86 and 88 is to be awakened. Computer 84 will then broadcast the appropriate wake-up packet on the LAN.

Additionally or alternatively, computer 84 may perform some or all of the functions of wake-up server 34 that are mentioned above. For example, computer 84 may serve as a proxy in communication between computers 86 and 88 and application server 32. In this capacity, computer 84 stores the power states of its peer computers on the LAN and, while the peers are powered down, periodically sends registration messages to server 32 specifying the application-specific IDs of the users of computers 86 and 88. Upon receiving an incoming application message from server 32, computer 84 may then send a wake-up packet to the appropriate peer computer.

Further additionally or alternatively, computer 84 may “impersonate” the application programs on computers 86 and 88 by carrying out the required service interactions with the application server as long as computers 86 and 88 are powered down. When an event occurs that makes it necessary to awaken one of the peer computers (for example, when computer 84 receives an incoming ring signal or instant message), computer 84 sends a wake-up packet to the peer computer. Once the peer computer has powered up, computer 84 may retransmit the last message that it received from server 32, so that the peer computer can take up the service interaction where computer 84 left off.

The above-mentioned relay, proxy and “impersonation” functions may be performed by two or more of the computers on the LAN. These functions may be performed in conjunction with wake-up server 34 or without reliance on a central wake-up server. In the latter case, in other words, each peer computer stores information such as the power states, application-specific IDs, and wake-up data of the other computers, so that each computer acts as a wake-up server with respect to the other computers. Furthermore, although in FIG. 4 computers 84, 86 and 88 are all located on the same LAN, a peer-to-peer network of this sort of computers may be established over the Internet or other WAN, wherein the computers maintain either a shared database or individual databases indicating the application-specific IDs, network addresses, power states, and wake-up data of the other computers. Thus, each of the computers is capable of waking up other computers in the peer-to-peer network when necessary, without reference to a central server.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for computer-based communication, comprising:
storing at a first computer records of correspondence between application-specific identifiers used in a network application and network addresses of computers on a network that are respectively associated with the application-specific identifiers;
powering down a second computer after storing at the first computer a record of the correspondence between an application-specific identifier and a network address associated with the second computer;
determining, while the second computer is powered down, that a message is to be directed by the network application to the application-specific identifier associated with the second computer; and
sending a wake-up packet over the network to the network address specified by the record, so as to cause the second computer to power up and respond to the message.

2. The method according to claim 1, wherein the network application comprises an Internet telephony application.

3. The method according to claim 1, wherein the network application comprises at least one of an instant messaging application, an e-mail application, a news application, and a video delivery application.

4. The method according to claim 1, wherein the network comprises the Internet.

5. The method according to claim 1, wherein the first and second computers are not located on a common local area network (LAN).

6. The method according to claim 1, wherein sending the wake-up packet comprises inserting in the wake-up packet a specific data pattern to which the second computer is configured to respond.

7. The method according to claim 6, wherein storing the record comprises storing an indication of the specific data pattern.

8. The method according to claim 6, wherein the specific data pattern comprises a physical address of the second computer.

9. The method according to claim 6, wherein the specific data pattern is contained in the message to be directed by the network application.

10. The method according to claim 1, wherein storing the records comprises recording respective power states of the computers, and wherein sending the wake-up packet comprises determining that the wake-up packet should be sent responsively to an indication in the record that the second computer is powered down.

11. The method according to claim 10, wherein determining that the message is to be directed comprises intercepting at an intermediary computer messages directed by the network to the application-specific identifier.

12. The method according to claim 11, wherein intercepting the messages comprises sending packets from the intermediary computer to a server associated with the network application so as to cause the server to send the messages to the intermediary computer while the second computer is powered down.

13. The method according to claim 12, wherein the intermediary computer is configured to serve as a proxy for the second computer.

14. The method according to claim 12, wherein the intermediary computer comprises a wake-up server, which stores the records and sends the wake-up packet.

15. The method according to claim 1, wherein the second computer is connected to the network via a local area network (LAN) together with a third computer, and wherein the third computer is configured to receive packets directed to the network address indicated by the record, and wherein sending the wake-up packet comprises prompting the third computer to send the wake-up packet to the second computer.

16. The method according to claim 1, wherein at least one of the records associates multiple network addresses with one of the application-specific identifiers.

17. The method according to claim 1, wherein at least two of the records associate different, respective application-specific identifiers with a single, common network address.

18. The method according to claim 1, wherein storing the records comprises storing an access control list identifying sources of the message that are permitted to cause the second computer to power up.

19. A method for computer-based communication, comprising:
storing at a first computer records of correspondence between network addresses of computers on a network and power states of the computers;
powering down a second computer while storing at the first computer a record indicating that the second computer has powered down;
determining, while the second computer is powered down, that a message is to be directed by a network application to the second computer; and
responsively to the record, sending a wake-up packet to the second computer, so as to cause the second computer to power up and respond to the message.

20. Apparatus for computer-based communication, comprising:
a memory, which is configured to store records of correspondence between application-specific identifiers used in a network application and network addresses of computers on a network that are respectively associated with the application-specific identifiers; and
a wake-up processor, which is arranged to receive, via the network, and to store in the memory a record of the correspondence between an application-specific identifier and a network address associated with a given computer, and to determine, while the given computer is powered down, that a message is to be directed by the network application to the application-specific identifier associated with the given computer, and to send a wake-up packet over the network to the network address specified by the record, so as to cause the given computer to power up and respond to the message.

21. The apparatus according to claim 20, wherein the network application comprises an Internet telephony application.

22. The apparatus according to claim 20, wherein the network application comprises at least one of an instant messaging application, an e-mail application, a news application, and a video delivery application.

23. The apparatus according to claim 20, wherein the network comprises the Internet.

24. The apparatus according to claim 20, wherein the wake-up processor and the given computer are not located on a common local area network (LAN).

25. The apparatus according to claim 20, wherein the wake-up processor is operative to insert in the wake-up packet a specific data pattern to which the given computer is configured to respond.

26. The apparatus according to claim 25, wherein the record in the memory comprises an indication of the specific data pattern.

27. The apparatus according to claim 25, wherein the specific data pattern comprises a physical address of the second computer.

28. The apparatus according to claim 25, wherein the specific data pattern is contained in the message to be directed by the network application.

29. The apparatus according to claim 20, wherein the records comprise an indication of respective power states of the computers, and wherein the wake-up processor is adapted to determine that the wake-up packet should be sent responsively to an indication in the record that the given computer is powered down.

30. The apparatus according to claim 29, wherein the wake-up processor is operative to intercept messages directed by the network to the application-specific identifier.

31. The apparatus according to claim 30, wherein the wake-up processor is operative to send packets to a server associated with the network application so as to cause the server to send the messages to the intermediary computer while the given computer is powered down.

32. The apparatus according to claim 31, wherein the wake-up processor is configured to serve as a proxy for the given computer.

33. The apparatus according to claim 20, wherein the given computer is connected to the network via a local area network (LAN) together with a peer computer, and wherein the wake-up processor is directed by the record to send the wake-up packet to the peer computer, so as to cause the peer computer to relay the wake-up packet to the second computer.

34. The apparatus according to claim 20, wherein at least one of the records associates multiple network addresses with one of the application-specific identifiers.

35. The apparatus according to claim 20, wherein at least two of the records associate different, respective application-specific identifiers with a single, common network address.

36. The apparatus according to claim 20, wherein the wake-up processor is adapted to maintain an access control list identifying sources of the message that are permitted to cause the given computer to power up, and to send the wake-up packet responsively to the access control list.

37. Apparatus for computer-based communication, comprising:
a memory, which is configured to store records of correspondence between network addresses of computers on a network and power states of the computers; and
a wake-up processor, which is arranged to receive, via the network, and to store in the memory a record indicating that a given computer is powered down, and to determine, while the given computer is powered down, that a message is to be directed by a network application to the second computer, and responsively to the record, to send a wake-up packet to the given computer, so as to cause the given computer to power up and respond to the message.
